(19) United States
(12) Patent Application Publication
(10) Pub. No.: US 2004/0160937 A1
(43) Pub. Date: Aug. 19, 2004

(54) Enhanced SDU discard signaling procedure in wireless communication systems

(76) Inventor: Sam Shiaw-Shiang Jiang, Hsinchu (TW)

Correspondence Address: Kao H. Lu, 686 Lawson Ave., Havertown, PA, 19083, US

(21) Appl. No.: 10/705,356

(22) Filed: Nov. 10, 2003

Related U.S. Application Data
(60) Provisional application No. 60/447,114, filed on Feb. 13, 2003.

(51) Int. Cl. H04J 3/24

(52) U.S. Cl. 370/349

(57) ABSTRACT

This invention of a modified MRW procedure eliminates any other SN_MRWᵢ fields in the MRW SUFI that have the same value as the SN_MRW_{LENGTH} field has. Therefore, the size of the MRW SUFI can be shortened and separated MWR procedures can be eliminated in some cases. In addition, the SDUs completely contained in the first transmitted AMD PDU after the termination of the MRW procedure can be processed as correctly received SDUs by the Receiver so that the transmitted data octets over the air are fully utilized to improve the overall system efficiency.

### CROSS REFERENCE APPLICATION

This application claims priority from U.S. Provisional Patent Application Nos. 60/447,114 filed on Feb. 13, 2003 and 60/459,171 filed on Mar. 31, 2003.

### BACKGROUND

This invention relates to wireless communication. More particularly, this invention provides more efficient way to handle the Service Data Unit (SDU) discard procedure for Acknowledged Mode transmission.

In acknowledged mode, when SDUs are discarded in a Sender due to time out or exceeding maximum number of transmissions, the information of discarded SDUs are signaled to the peer Receiver so that the Receiver can discard Acknowledged Mode Data Protocol Data Units (AMD PDUs) carrying these SDUs and advance its receiving window accordingly. The Sender uses a STATUS PDU containing the ‘Move Receiving Window’ super-field (MRW SUFI) to request the Receiver to move its reception window and optionally to indicate the set of Radio Link Control layer SDUs (RLC SDUs) that should be discarded. This SDU discard signaling procedure is called an SDU discard with explicit signaling procedure or, simply, a Move Receiving Window (MRW) procedure.

FIG. 1 illustrates the MRW SUFI structure 2. The Type field 4 indicates the type of this SUFI. The LENGTH field 6 contains 4 bits. The values “0001” through “1111” indicate that 1 through 15 SN_MRWᵢ fields are present respectively. The value “0000” indicates that one SN_MRWᵢ field is present and that the discarded RLC SDU extends above the configured transmission window in the Sender.

Next, each of the SN_MRWᵢ fields 8-14 has 12 bits. When the “Send MRW” is configured, the Sender uses an SN_MRWᵢ field to indicate the end of each discarded RLC SDU, i.e. the number of SN_MRWᵢ fields shall equal to the number of RLC SDUs discarded by that MRW SUFI. When the “Send MRW” is not configured, the Sender uses an SN_MRWᵢ field to indicate the end of the last RLC SDU to be discarded in the Receiver and optionally uses additional ones to indicate the end of other discarded RLC SDUs. The SN_MRWᵢ has the Sequence Number (SN) of the AMD PDU that contains the “Length Indicator” of the i-th RLC SDU to be discarded in the Receiver (except for SN_MRW_{LENGTH} when N_{LENGTH}=0). The order of the SN_MRWᵢ fields shall be in the same sequential order as the RLC SDUs that they refer to. Furthermore, the Sender uses the SN_MRW_{LENGTH} to request the Receiver to discard all AMD PDUs with their SN less than SN_MRW_{LENGTH}, and to move the reception window accordingly.

At last, the N_{LENGTH} field 16 has 4 bits. The Sender uses N_{LENGTH} together with SN_MRW_{LENGTH} to indicate the end of the last RLC SDU to be discarded in the Receiver. N_{LENGTH} indicates which “Length Indicator” in the AMD PDU with its SN specified in SN_MRW_{LENGTH} corresponds to the last RLC SDU to be discarded in the Receiver. When N_{LENGTH}=0 indicates that the last RLC SDU ended in the AMD PDU with the SN of (SN_MRW_{LENGTH}−1) and that the first data octet in the AMD PDU with “Sequence Number” SN_MRW_{LENGTH} is the first data octet to be reassembled next.

FIG. 2 illustrates the elementary procedure for SDU discard with explicit signalling. When an MRW procedure is initiated, the Sender transmits a STATUS PDU containing an MRW SUFI. Upon receiving the MRW SUFI, the Receiver sends a STATUS PDU containing a corresponding MRW_ACK SUFI back to the Sender. The MRW procedure ends when the Sender receives the MRW_ACK SUFI from the Receiver. The Sender shall initiate an MRW procedure if one of the following trigger events is detected:

(1) “Timer based SDU discard with explicit signalling” is configured, the timer Timer_Discard of a SDU expires and one or more segments of the discarded SDU were submitted to the lower layer;

(2) “Timer based SDU discard with explicit signalling” is configured, a timer Timer_Discard expires for an SDU and a “Send MRW” is configured; or

(3) “SDU discard after MaxDAT number of transmissions” is configured, and maximum number of transmissions is reached (i.e. VT(DAT)≧MaxDAT) for an AMD PDU.

In other words, if “Timer based SDU discard with explicit signalling” is configured, for every SDU received from upper layers, the Sender shall start a timer Timer_Discard. When the timer Timer_Discard of an SDU expires, the Sender shall discard the SDU. In addition, upon discarding the SDU, the Sender shall initiate an MRW procedure if either a “Send MRW” is configured or at least one segment of the discarded SDU had been submitted to the lower layer. On the other hand, if “SDU discard after MaxDAT number of transmissions” is configured, when the number of transmissions of an AMD PDU reaches MaxDAT, the Sender shall discard all SDUs that have segments in the AMD PDU and shall initiate an MRW procedure.

Furthermore, when the MRW procedure is initiated because of Timer_Discard expired, the Sender shall discard all SDUs up to and including the SDU for which the timer Timer_Discard expired. On the other hand, when the MRW procedure is initiated because of the maximum number of transmissions is reached (i.e. VT(DAT)≧MaxDAT) for an AMD PDU, the Sender discards all SDUs that have segments in AMD PDUs with their sequence numbers (SN) inside the interval VT(A)≦SN≦X, where X is the value of the SN of the AMD PDU with VT(DAT)≧MaxDAT and VT(A) is the SN of the first in-sequence AMD PDU that is not acknowledged yet.

The Sender starts the timer Timer_MRW once a MRW procedure is initiated. However, there will be only one Timer_MRW running at one time, so if a new MRW procedure is triggered when the timer Timer_MRW is already active, no new MRW SUFIs shall be sent before the current MRW procedure is terminated. The MRW procedure is terminated when the Sender receives certain STATUS PDU/piggybacked STATUS PDU containing an MRW_ACK SUFI from the receiver.

Upon termination of the MRW procedure, the Sender shall stop the timer Timer_MRW and update VT(A) and VT(MS) according to the received STATUS PDU/piggybacked STATUS PDU. The Sender shall not confirm to upper layers the SDUs that are requested to be discarded.

FIG. 3 illustrates the detail logical flow of setting up an MRW SUFI in an MRW procedure. When an MRW procedure is triggered Step 100, the process starts to set up a STATUS PDU with MRW SUFI Step 102. The process checks if “Send MRW” is configured Step 104, if it is, the process further checks if there are more than 15 discarded SDUs Step 110, if it is, the process sets up an MRW SUFI for the first 15 SDUs where one SN_MRWᵢ field for each corresponding discarded SDU Steps 112 and 114. The Sender will send the rest discarded SDUs in the next MRW procedure. On the other hand, if “Send MRW” is not configured, the process sets the last SN_MRWᵢ field for the last discarded SDU Step 106. The process will optionally set other SN_MRWᵢ fields for other discarded SDUs Step 108.

At Step 116, the process checks if the last discarded SDU ends in a PDU which contains the “Length Indictor” of the last discarded SDU and contains no new SDUs. If the condition of Step 116 is true, then the process sets the last SN_MRWᵢ field (SN_MRW_{LENGTH}) equal to (the SN of the PDU at which the last discarded SDU ends+1), and N_{LENGTH} equal to 0 in Step 118. Otherwise, if the condition of Step 116 is false, the process sets the last SN_MRWi (SN_MRW_{LENGTH}) equal to the SN of the PDU which contains the “Length Indicator” of the last discarded SDU and N_{LENGTH} equal to the number of “Length Indicators” corresponding to discarded SDUs within the PDU which contains the “Length Indictor” of the last discarded SDU Step 120. In Step 122, the process sets each of the other SN_MRWᵢ fields equal to the SN of the AMD PDU containing the “Length Indictor” of the corresponding discarded SDU.

Furthermore, in Step 124, the process will check if there is only one SN_MRWᵢ field and if it contains a discarded SDU extended above the configured transmission window. If it is, then the process sets “LENGTH” equal to 0 in Step 126. Otherwise, the process sets “LENGTH” equal to the number of SN_MRWᵢ fields Step 128. At Step 130, the process is ready to transmit the STATUS PDU with the MRW SUFI.

Based on the received MRW SUFI, the Receiver shall shift its reception window boundaries accordingly and discard AMD PDUs carrying these discarded SDUs. FIG. 4 illustrates the procedure at the Receiver side. Upon reception of the STATUS PDU/piggybacked STATUS PDU containing an MRW SUFI Step 200, the Receiver shall check first if the LENGTH field in the received MRW SUFI is 0 Step 202. If it is, the Receiver shall decide that the number of the SN_MRWᵢ field is equal to 1 Step 210, consider the value of the SN_MRWₗ field to be above or equal to VR(R) Step 212 and discard PDUs up to and including the PDU with SN equal to (SN_MRW_{LENGTH}−1) Step 214. However, if the LENGTH field is not 0, the Receiver decides that the number of the SN_MRWᵢ fields is equal to LENGTH Step 204, considers the value of the SN_MRWₗ field to be less than VR(MR) Step 206, assumes that all the SN_MRWᵢ fields are in sequential order Steps 208 and goes to Step 214.

Next, the Receiver shall check If the N_{LENGTH} field in the received MRW SUFI is 0 at Step 216. If it is, the Receiver reassembles from the first data octet of the AMD PDU with the PDU having its sequence number indicated in SN_MRW_{LENGTH} Step 222. Otherwise, if N_{LENGTH} is not equal to 0, the Receiver shall further discard the data octets in the AMD PDU with its SN specified in SN_MRW_{LENGTH} up to and including the data octet indicated by the N_{LENGTH}'th “Length Indicator” field of the AMD PDU Step 218. The Receiver reassembles from the succeeding data octets in the AMD PDU of the SN specified in SN_MRW_{LENGTH} after the last discarded data octet Step 220.

Furthermore, if “Send MRW” is configured, the Receiver informs upper layers about all of the discarded SDUs that were not previously delivered to upper layer nor discarded by other MRW SUFIs Steps 224, 226. Otherwise, the Receiver won't inform upper layers about all discarded SDUs. Next, the Receiver shall update the state variables VR(R), VR(H) and VR(MR) according to the received STATUS PDU/piggybacked STATUS PDU Step 228. Then, the Receiver returns the Sender an MRW_ACK SUFI in a STATUS PDU/piggybacked STATUS PDU Step 230.

Overall, in the prior art after an MRW procedure is terminated, under N_{LENGTH}>1 situation, the Sender will send the AMD PDU with its SN specified in the SN_MRW_{LENGTH}field, in turn the PDU contains complete contents of at least (N_{LENGTH}−1) SDUs. However, the Receiver will discard those SDUs when the Receiver receives this AMD PDU. Thus, the transmission efficiency is degraded in the prior art.

Three examples are used to illustrate the above-mentioned problem:

[Example 1] When the “Send MRW” is configured, the Sender sends a STATUS PDU with the MRW SUFI as shown in FIG. 7A. This MRW SUFI indicates that two SDUs ended at the AMD PDU with SN=5 are discarded, that one of the discarded SDUs, the second one, is completely contained in this AMD PDU and that there are data octets of the next outstanding SDU contained in this AMD PDU.

[Example 2 ] While the “Send MRW” is not configured, the MRW SUFI of the first example can be optionally reduced to one SN_MRWᵢ field as shown in FIG. 7B.

In both examples, according to the prior art, after the Receiver responds a STATUS PDU, which contains either a legal MRW_ACK SUFI or an appropriate ACK SUFI, the Sender's MRW procedure is terminated. The Sender shall transmit or re-transmit the AMD PDU with SN=5. When the Receiver received this AMD PDU, the Receiver discards the SDUs that have segments in the AMD PDU with SN=SN_MRW_{LENGTH}=5 up to and including the data octet indicated by the N_{LENGTH}'th ( the second in Example 1 and Example 2) “Length Indicator” field of the AMD PDU and reassembles from the succeeding data octet in the AMD PDU after the discard. If the values of the first two “Length Indicator” field of the AMD PDU are 10 and 100 respectively, the first 100 octets of the data field are transmitted even it is already known that they are to be discarded anyway by the Receiver.

Furthermore, in the case that “Send MRW” is configured, the maximum number of discarded SDUs that can be signaled by a single MRW SUFI is 15. This is due to the facts that the LENGTH field is 4 bit in length and that both LENGTH=0 and 1 refers to one SN_MRWₗ field in the MRW SUFI to differentiate the cases that the discarded SDU ends above or within the configured transmission window.

Therefore, if there are more than 15, say 16, SDUs to be discarded in the Sender, two separate MRW procedures must be performed before the normal data transmission can be resumed. Example 3 is an example when the Sender is in the condition that “Send MRW” is configured and has 16 discarded SDUs.

[Example 3] The sixteen discarded SDUs end at PDUs with SN=1, 2, 2, 3, 4, 4, 5, 6, 7, 8, 8, 9, 10, 12, 12, 12, respectively. The PDU with SN=12 contains other outstanding octets, which are not to be discarded. In this scenario, two separate MRW procedures need be performed in sequence, one after the other. The corresponding MRW SUFIs are shown in FIG. 7C and FIG. 7D. Note that the last two discarded SDUs are contained completely in the PDU of SN=12, which will be transmitted after the second MRW procedure is terminated. Not only the transmission of the last two discarded SDUs is wasted, the second MRW procedure is also unnecessary.

### SUMMARY

The MRW procedure of the prior art apparently has room for improvement. A modified MRW procedure of this invention can be more effective.

### BRIEF DESCRIPTION OF THE DRAWINGS

Following drawings with reference numbers and exemplary embodiments are referenced for explanation purpose.

FIG. 1 illustrates an MRW SUFI structure in a STATUS PDU;

FIG. 2 illustrates the simplified MRW procedure between the Sender and the Receiver;

FIG. 3 briefly illustrates how the MRW procedure sets up the MRW SUFI by the Sender;

FIG. 4 briefly illustrates how a Receiver processes a received MRW SUFI;

FIG. 5 illustrates the modification of the MRW procedure in the Sender of this invention;

FIG. 6 briefly illustrates how the Receiver of this invention processes an MRW SUFI.

FIGS. 7A-7E illustrate various MRW SUFIs for Examples 1-3.

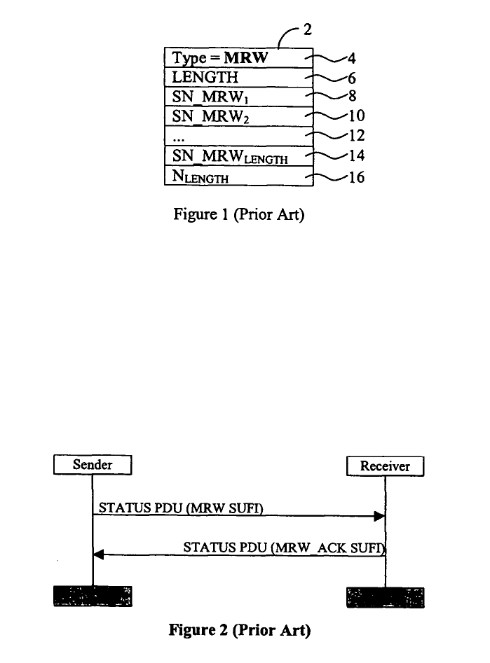

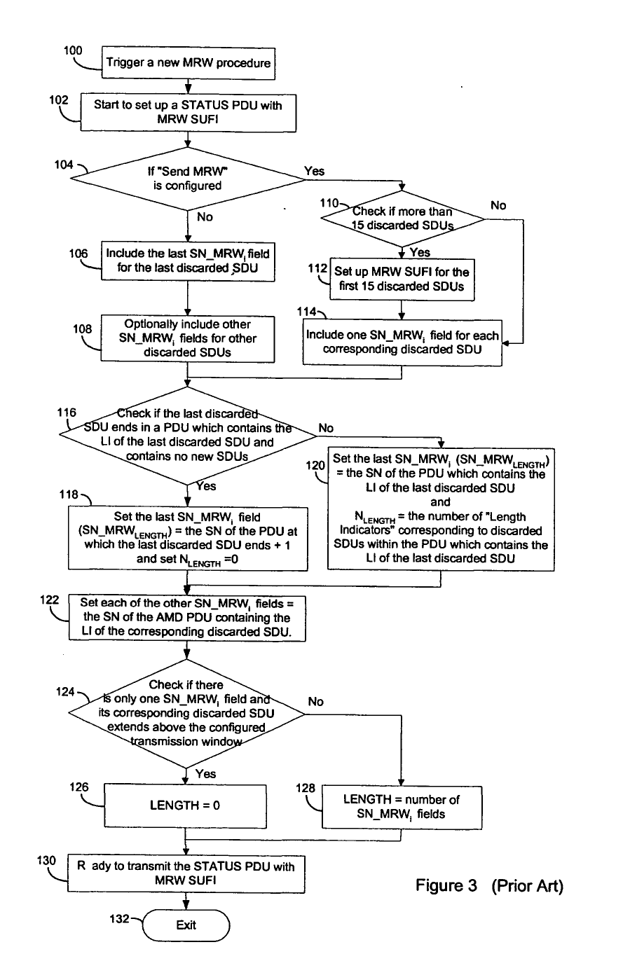

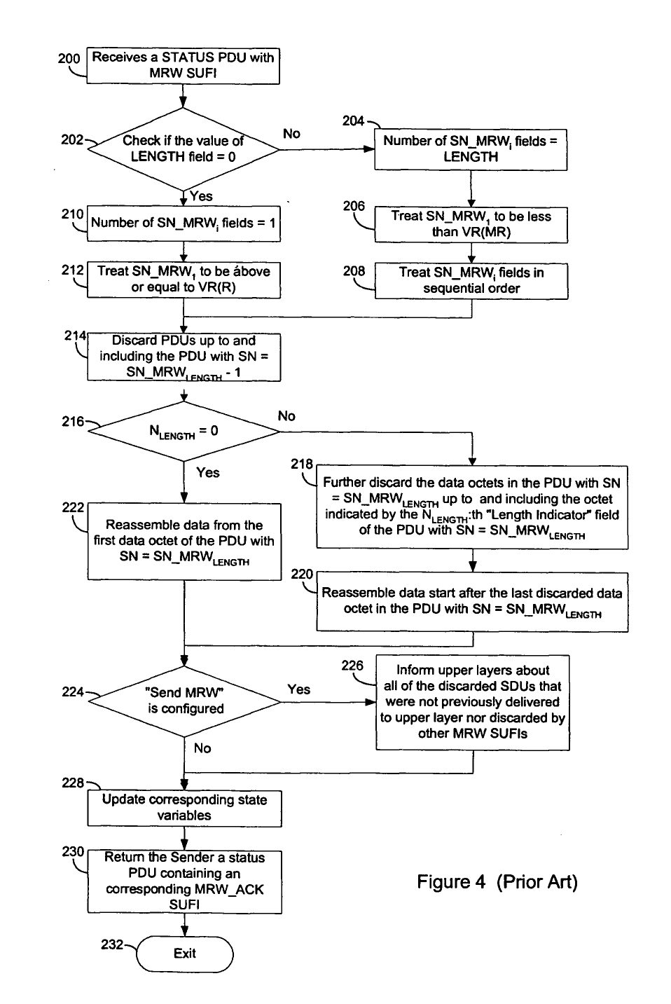

### DESCRIPTION OF THE INVENTION

This invention uses the same basic MRW super-field structure as the prior art does but modifies the ways to set up MRW SUFI in the MRW procedure and the ways to interpret the received MRW SUFI by the Receiver.

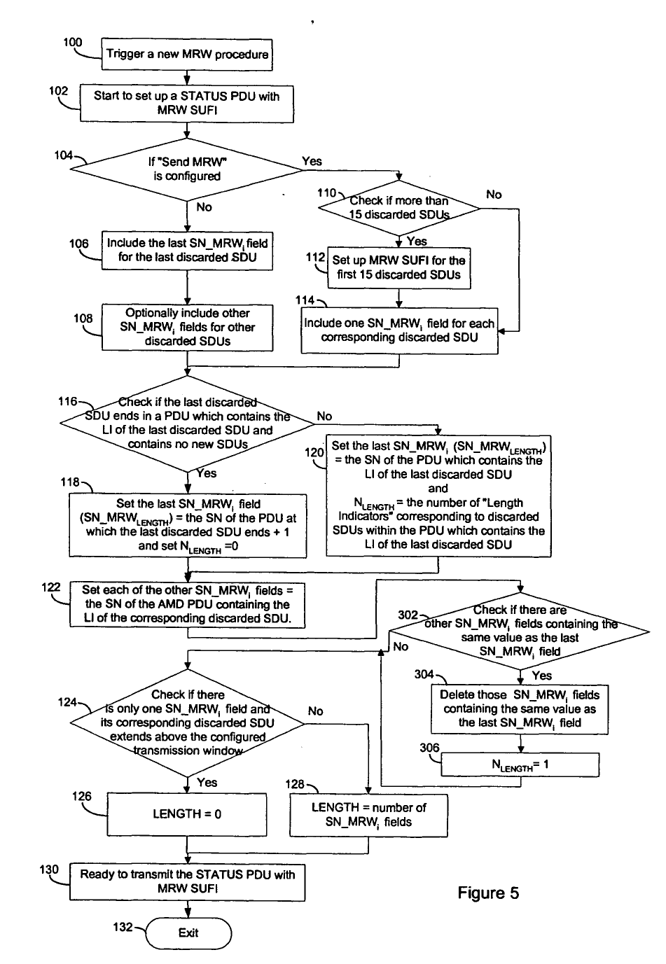

According to the prior art, when receiving an MRW SUFI with its N_{LENGTH} field having value greater than or equal to 1, the Receiver will discard the data octets of the PDU, whose SN is specified in SN_MRW_{LENGTH}, up to and including the data octet indicated in the N_{LENGTH}'th “Length Indicator”. By this invention, a Sender implemented with the modified MRW procedure eliminates any other SN_MRWᵢ fields in the MRW SUFI that have the same value as the SN_MRW_{LENGTH} has. Refer to Steps 302, 304 and 306 of FIG. 5 for the differences in setting up an MRW SUFI between this invention and the prior art. After Step 122, the new process will check if there are other SN_MRWᵢ fields containing the same value as the SN_MRW_{LENGTH} has. If there is no such SN_MRWᵢ field, the process proceeds to Step 124. Otherwise, the process deletes those SN_MRWi fields containing the same value as the SN_MRW_{LENGTH} field has. Then, at Step 306, the process sets N_{LENGTH}=1. Therefore, the length of N_{LENGTH} can be 1 bit only by this invention instead of 4 bits needed in the prior art.

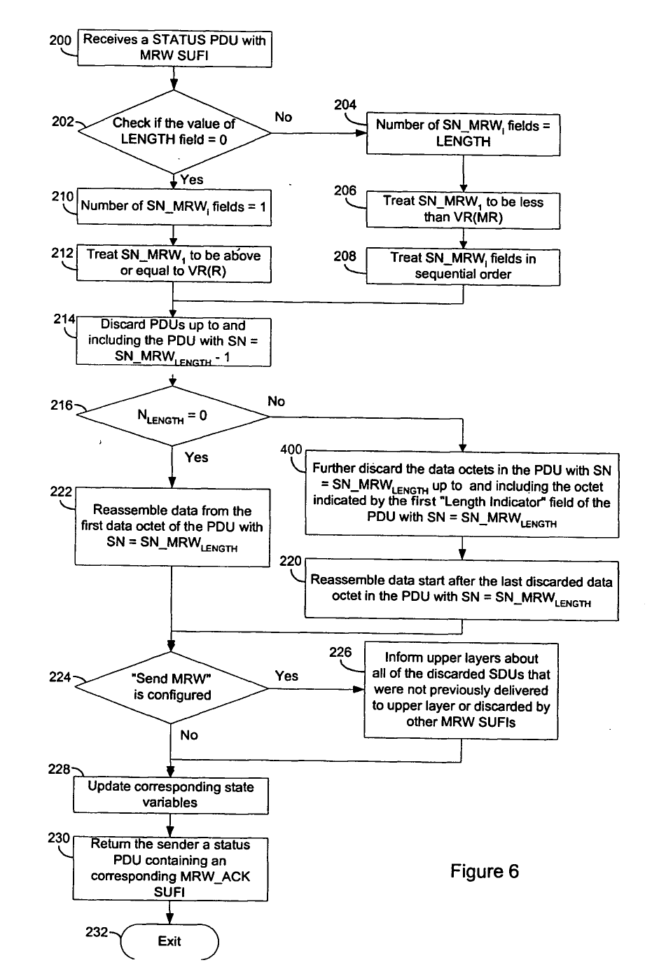

The Receiver of the prior art can handle the MRW SUFI sent from the modified Sender of this invention. However, the Receiver can also be modified as shown in FIG. 6 to work with the Sender of the prior art. Upon receiving the AMD PDU of SN=SN_MRW_{LENGTH} after the termination of the MRW procedure of the Sender, in Step 216 of FIG. 6, the Receiver checks if the N_{LENGTH} of the receiving MRW SUFI is equal to 0. If it is, then the process proceeds to Step 222. Otherwise, if N_{LENGTH} is not equal to 0, the process shall discard the data octets up to and including the data octet indicated in the first “Length Indicator” field of the AMD PDU of the SN specified in SN_MRW_{LENGTH}. The receiver shall reassemble new data beginning from the succeeding data octet in the AMD PDU with its SN specified in SN_MRW_{LENGTH} after the last discarded data octet.

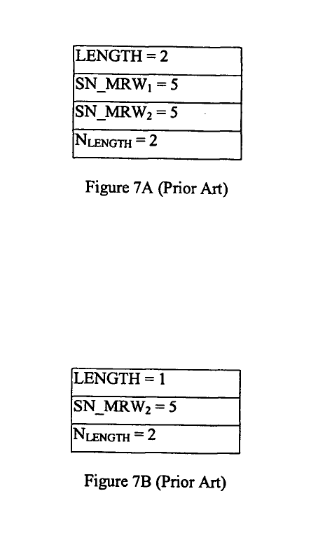

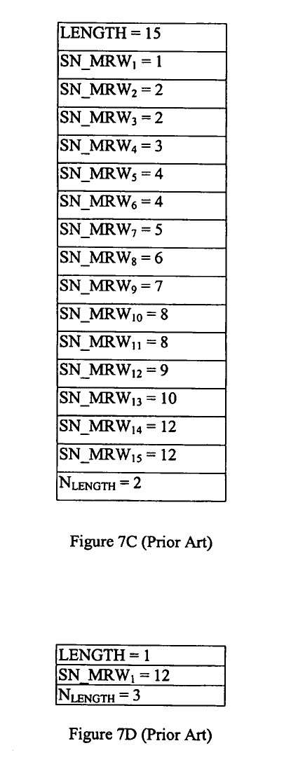

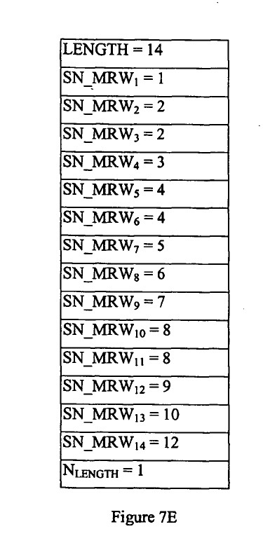

In Example 1 and Example 2 described above, the 100−10=90 octets of the first complete SDU contained in the AMD PDU of SN=5 can be processed by the Receiver as a correctly received SDU by this invention. Furthermore, when “Send MRW” is configured, the MRW SUFI does not need to indicate the discarded SDUs that are completely contained in the PDU with SN=SN_MRW_{LENGTH}. In addition, the maximum value of N_{LENGTH} field can be limited to 1 so that the length of N_{LENGTH} can be 1 bit only by this invention instead of 4 bits in the prior art. Therefore, in the scenario of Example 3, only one MRW procedure is needed to signal the discarded SDUs by this invention. In addition, the MRW SUFI can be shortened by one SN_MRWᵢ field (12 bits). The shortened MRW SUFI is given as FIG. 7E.

Using the invention, the SDUs completely contained in the first transmitted AMD PDU after the termination of the MRW procedure can be processed as correctly received SDUs so that the transmission efficiency of the wireless communication system is enhanced. In addition, the SDUs to be discarded by the Sender need not be signalled to the Receiver if they are completely contained in the PDU of SN=SN_MRW_{LENGTH}, i.e., the first transmitted AMD PDU after the termination of the MRW procedure so that the size of the MRW SUFI can be shortened and separated MRW procedures can be eliminated in some cases.

What is claimed is:

1. A modified MRW procedure to prepare a status PDU with a MRW SUFI, which is used by a sender to inform a receiver about moving its reception window boundaries or discarding certain SDUs, wherein the procedure sets up the fields of a MRW SUFI, such as Type, LENGTH, SN_MRWᵢ, SN_MRW_{LENGTH} (the last SN_MRWᵢ field) and N_{LENGTH} accordingly; and each PDU has been assigned a corresponding sequential number (SN), wherein the method comprises the steps of:
at the sender:
triggering the MRW procedure upon a plurality of trigger events;
checking the status of a “Send MRW” and acting accordingly;
setting up the SN_MRW_{LENGTH} field for the last discarded SDU and the N_{LENGTH} field accordingly;
while there exists a SN_MRWᵢ field, other than the SN_MRW_{LENGTH} field, containing the same value as the SN_MRW_{LENGTH} field has,
deleting the SN_MRWᵢ field containing the same value as the SN_MRW_{LENGTH} field has;
setting N_{LENGTH} equal to 1; and
setting up the LENGTH field accordingly.

2. The method as claimed in claim 1; wherein one of the trigger events is when a time out occurs.

3. The method as claimed in claim 1; wherein one of the trigger events is that the number of retry of sending a PDU exceeds the maximum number of retransmission.

4. The method as claimed in claim 1; wherein setting up the SN_MRW_{LENGTH} field for the last discarded SDU and the N_{LENGTH} field accordingly further comprises the steps of:
if the last discarded SDU ends in a PDU containing the “Length Indicator” of the last discarded SDU and the PDU contains no new SDU;
setting SN_MRW_{LENGTH} equal to (the SN of the PDU containing the “Length Indicator” of the last discarded SDU+1);
setting N_{LENGTH} equal to 0;
otherwise if the PDU contains at least one segment of a new SDU;,
setting SN_MRW_{LENGTH} equal to (the SN of the PDU containing the “Length Indicator” of the last discarded SDU); and
setting N_{LENGTH} equal to 1.

5. The method as claimed in claim 1; wherein setting up the LENGTH field accordingly further comprising the following steps of:
if there is only one SN_MRWᵢ field in the MRW SUFI to be sent and the SN of the SN_MRWᵢ field extends above the configured transmission window;
setting LENGTH equal to 0; and
otherwise, setting LENGTH equal to the number of SN_MRWᵢ fields.

6. The method as claimed in claim 1; wherein checking the status of the “Send MRW” further comprising the steps of:
if a “Send MRW” flag is configured;
if there is more than 15 discarded SDUs;
setting up the MRW SUFI for the first 15 discarded SDUs;
handling the rest discarded SDUs accordingly; and
assigning each SN_MRWi with the SN of each corresponding discarded SDU.

7. The method as claimed in claim 6; wherein handling the rest discarded SDUs accordingly further comprising the steps of:
if the PDU that contains the Length Indicator of the fifteenth discarded SDU contains all the rest discarded SDUs and at least one segment of an SDU that is not discarded;
neglecting the rest discarded SDUs; and
otherwise, handling the rest discarded SDUs in another MRW procedure.

8. The method as claimed in claim 1; wherein the length of the N_{LENGTH} field can be one bit.

9. A modified MRW procedure to prepare a status PDU with a MRW SUFI, which is used by a sender to inform a receiver about moving its reception window boundaries or these SDUs should be discarded, wherein the procedure sets up the fields of a MRW SUFI, such as Type, LENGTH, SN_MRWᵢ, SN_MRW_{LENGTH} (the last SN_MRWᵢ field) and N_{LENGTH} accordingly; and each PDU has been assigned a corresponding sequential number (SN), wherein the method comprises the steps of: at the receiver:
receiving a status PDU with a MRW SUFI from the sender;
checking the value of the LENGTH field and discarding PDUs accordingly;
if the value of the N_{LENGTH} field is equal to 0;
reassembling data from the first data octet of the PDU having its SN equal to SN_MRW_{LENGTH};
if the value of the N_{LENGTH} field is not equal to 0
discarding data octets in the PDU having its SN equal to SN_MRW_{LENGTH} up to and including the data octet indicated by the first “Length Indicator” field of the same PDU; and
reassembling data from the succeeding data octet after the last discarded data octet of the PDU having its SN equal to SN_MRW_{LENGTH}.

10. The method as claimed in claim 9, wherein checking the value of the LENGTH field and discarding PDUs accordingly further comprising the steps of:
if the value of the LENGTH field is equal to 0;
processing the received MRW SUFI as if there is only one SN_MRWᵢ field,
SN_MRW_{LENGTH};
otherwise if the value of the LENGTH field is not equal to 0;
processing the received MRW SUFI as if there are LENGTH number of SN_MRWᵢ fields, SN_MRWₗ up to SN_MRW_{LENGTH}; and
discarding PDUs up to and including the PDU having its SN equal to (SN_MRW_{LENGTH}−1).

11. A sender using a modified MRW procedure to prepare a status PDU with a MRW SUFI to inform a receiver about moving its reception window boundaries or discarding certain SDUs, wherein the procedure sets up the fields of a MRW SUFI, such as Type, LENGTH, SN_MRWᵢ, SN_MRW_{LENGTH} (the last SN_MRWᵢ field) and N_{LENGTH} accordingly; and each PDU has been assigned a corresponding sequential number (SN), wherein the sender comprises:
means for triggering the MRW procedure upon a plurality of trigger events;
means for checking the status of a “Send MRW” and acting accordingly;
means for setting up the SN_MRW_{LENGTH} field for the last discarded SDU and the N_{LENGTH} field accordingly;
while there exists a SN_MRWᵢ field, other than the SN_NMRW_{LENGTH} field, containing the same value as the SN_MRW_{LENGTH} field has,
,means for deleting the SN_MRWᵢ field containing the same value as the SN_MRW_{LENGTH} field has;
means for setting N_{LENGTH} equal to 1; and means for setting up the LENGTH field accordingly.

12. The sender as claimed in claim 11; wherein means for setting up the SN_MRW_{LENGTH} field for the last discarded SDU and the N_{LENGTH} field accordingly further comprises:
means for checking if the last discarded SDU ends in a PDU containing the “Length Indicator” of the last discarded SDU and the PDU contains no new SDU;
means for setting SN_MRW_{LENGTH} equal to (the SN of the PDU containing the “Length Indicator” of the last discarded SDU+1);
means for setting N_{LENGTH} equal to 0;
means for checking if the PDU contains at least one segment of a new SDU;,
means for setting SN_MRW_{LENGTH} equal to (the SN of the PDU containing the “Length Indicator” of the last discarded SDU); and
means for setting N_{LENGTH} equal to 1.

13. The sender as claimed in claim 11; wherein means for setting up the LENGTH field accordingly further comprising:
means for checking if there is only one SN_MRWᵢ field in the MRW SUFI to be sent and
the SN of the SN_MRWᵢ field extends above the configured transmission window;
means for setting LENGTH equal to 0; and
otherwise, means for setting LENGTH equal to the number of SN_MRWᵢ fields.

14. The sender as claimed in claim 11; wherein means for checking the status of the “Send MRW” further comprising:
means for checking if a “Send MRW” flag is configured;
means for checking if there is more than 15 discarded SDUs;
means for setting up the MRW SUFI for the first 15 discarded SDUs;
means for handling the rest discarded SDUs accordingly; and
means for assigning each SN_MRWᵢ with the SN of each corresponding discarded SDU.

15. The sender as claimed in claim 14; wherein means for handling the rest discarded SDUs accordingly further comprising:
means for checking if the PDU that contains the Length Indicator of the fifteenth discarded SDU contains all the rest discarded SDUs and at least one segment of an SDU that is not discarded;
means for neglecting the rest discarded SDUs; and
otherwise, means for handling the rest discarded SDUs in another MRW procedure.

16. A receiver using a modified MRW procedure to receive a status PDU with a MRW SUFI, which is sent by a sender to inform the receiver about moving its reception window boundaries or these SDUs should be discarded, wherein the procedure sets up the fields of a MRW SUFI, such as Type, LENGTH, SN_MRWᵢ, SN_MRW_{LENGTH} (the last SN_MRWᵢ field) and N_{LENGTH} accordingly; and each PDU has been assigned a corresponding sequential number (SN), wherein the receiver comprises:
means for receiving a status PDU with a MRW SUFI from the sender;
means for checking the value of the LENGTH field and discarding PDUs accordingly;
means for checking if the value of the N_{LENGTH} field is equal to 0;
means for reassembling data from the first data octet of the PDU having its SN equal to SN_MRW_{LENGTH};
means for checking if the value of the N_{LENGTH} field is not equal to 0
means for discarding data octets in the PDU having its SN equal to SN_MRW_{LENGTH} up to and including the data octet indicated by the first “Length Indicator” field of the same PDU; and
means for reassembling data from the succeeding data octet after the last discarded data octet of the PDU having its SN equal to SN_MRW_{LENGTH}.

17. The receiver as claimed in claim 16, wherein means for checking the value of the LENGTH field and discarding PDUs accordingly further comprising:
means for checking if the value of the LENGTH field is equal to 0;
means for processing the received MRW SUFI as if there is only one SN_MRWᵢ field, SN_MRW_{LENGTH};
means for checking if the value of the LENGTH field is not equal to 0;
means for processing the received MRW SUFI as if there are LENGTH number of SN_MRWᵢ fields, SN_MRWᵢ up to SN_MRW_{LENGTH}; and
means for discarding PDUs up to and including the PDU having its SN equal to (SN_MRW_{LENGTH}−1).
